(19) United States
(12) Patent Application Publication
(10) Pub. No.: US 2018/0353019 A1
(43) Pub. Date: Dec. 13, 2018

(54) Disposable Liner

(71) Applicant: Debra Deanne ParkerHall, Matthews, NC (US)

(72) Inventor: Debra Deanne ParkerHall, Matthews, NC (US)

(21) Appl. No.: 15/616,478

(22) Filed: Jun. 7, 2017

(51) Int. Cl. A47K 11/10

(52) U.S. Cl. CPC A47K 11/105; A61G 9/003

(57) ABSTRACT

A disposable liner is an apparatus that allows a bedpan to be reusable while limiting the cleaning between uses. The apparatus includes a lining sheet, an elastic loop, a first finger slot, and a second finger slot. The lining sheet upholds the waste and prevents the waste from coming into contact with the bedpan. The elastic loop secures the lining sheet onto a bedpan and closes an opening of the apparatus in order to prevent the waste contained within the lining sheet from escaping. The first finger slot and the second finger slot allows the user to access the elastic loop. The elastic loop is perimetrically and slidably mounted around the lining sheet so that the user may remove the apparatus from the bedpan without coming into contact with the waste. The elastic loop is preferably slidably positioned within an annular sleeve that is perimetrically connected around the lining sheet.

### FIELD OF THE INVENTION

The present invention relates generally to liner. More specifically, the present invention is a disposable liner that securely wraps around a bed pan.

### BACKGROUND OF THE INVENTION

Bedpans are a common fixture of hospital care that need constant replacing in order to maintain the hygiene of a patient. Bedpans are typically reused and sanitized, however, the process of sanitization requires plenty of time and effort. Nurses and other caretakers must monitor vitals and a variety of needs of a patient, and bedpan maintenance distracts the nurse or caretaker and requires the energy and time of the nurse or caretaker.

The present invention serves to reduce the maintenance of bedpans. The present invention accommodates a variety of bedpans regardless of shape or size. The present invention contains the waste released into the bedpan while in use and throughout the disposal of the present invention. The present invention allows for multiple uses of a bedpan without the need of extensive cleaning while maintaining the proper hygiene of a patient.

### BRIEF DESCRIPTION OF THE DRAWINGS

FIG. 1 is a perspective view of the present invention.

FIG. 2 is an exploded view of the present invention.

FIG. 3 is a left perspective view of the present invention engaged with a bedpan.

FIG. 4 is a right perspective view of the present invention engaged with a bedpan.

FIG. 5 is a perspective view of the present invention, wherein the lining sheet contains waste, and wherein the elastic loop is in a knotted configuration.

### DETAILED DESCRIPTION OF THE INVENTION

All illustrations of the drawings are for the purpose of describing selected versions of the present invention and are not intended to limit the scope of the present invention.

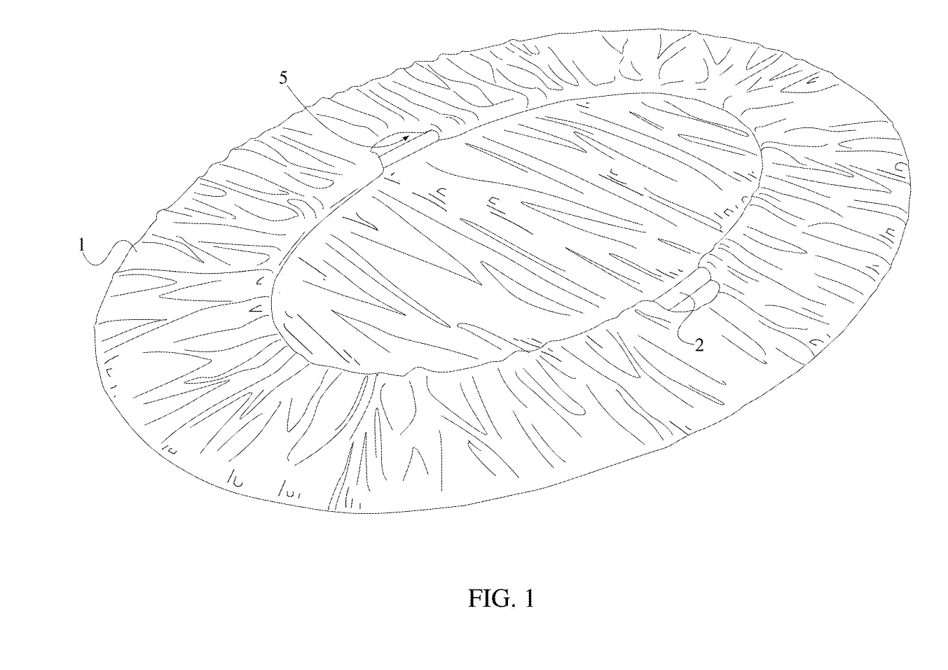

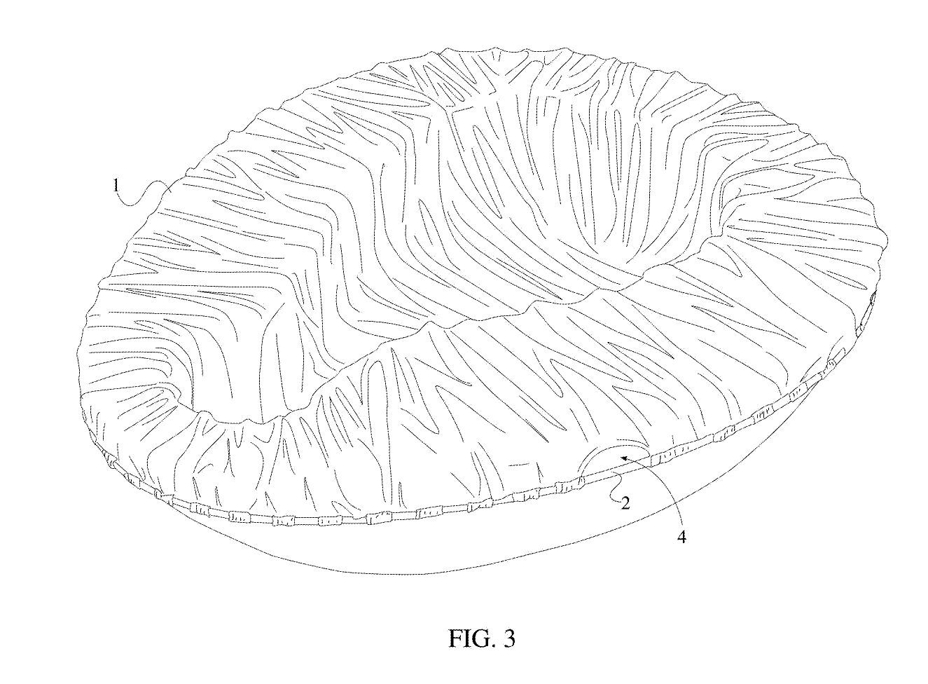

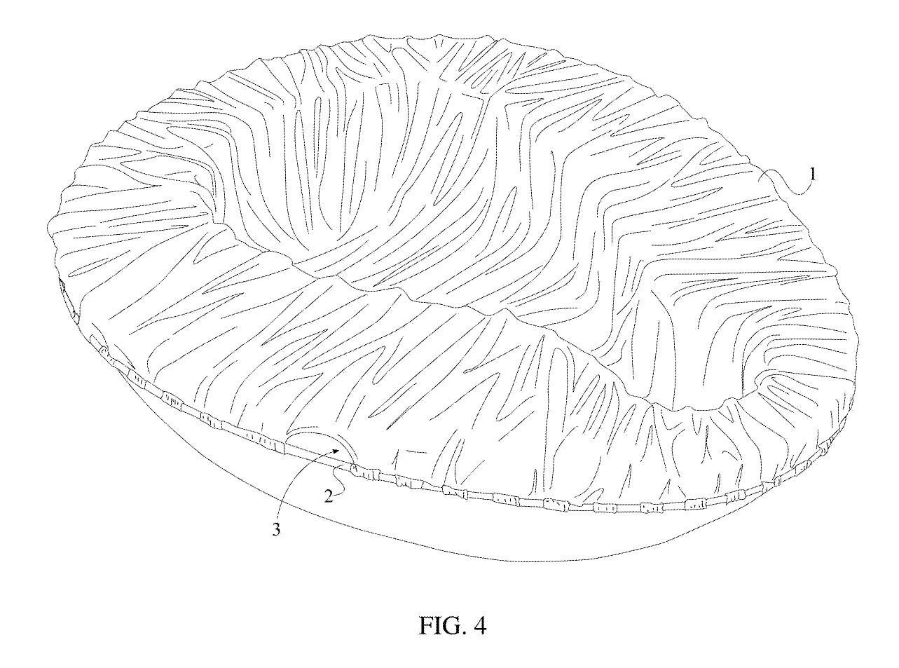

The present invention is a disposable liner that facilitates the removal of waste from a bedpan. The present invention reduces or eliminates a mess from waste within a bedpan. The present invention comprises a lining sheet 1, an elastic loop 2, a first finger slot 3, and a second finger slot 4, as seen in FIG. 1, FIG. 3, and FIG. 4. The lining sheet 1 prevents waste from coming into contact with an engaged bedpan. The lining sheet 1 is flexible and allows the present invention to accommodate bedpans of varying shapes. The elastic loop 2 secures the lining sheet 1 around the engaged bedpan. Due to the elasticity of the elastic loop 2, the present invention accommodates varying sizes of bedpans. The elastic loop 2 also allows a user to secure waste that is released into the bedpan and contained within the lining sheet 1. The first finger slot 3 and the second finger slot 4 allows a user to access the elastic loop 2. The first finger slot 3 and the second finger slot 4 both have a semi-circular shape as to accommodate the circumferential shape of the elastic loop 2.

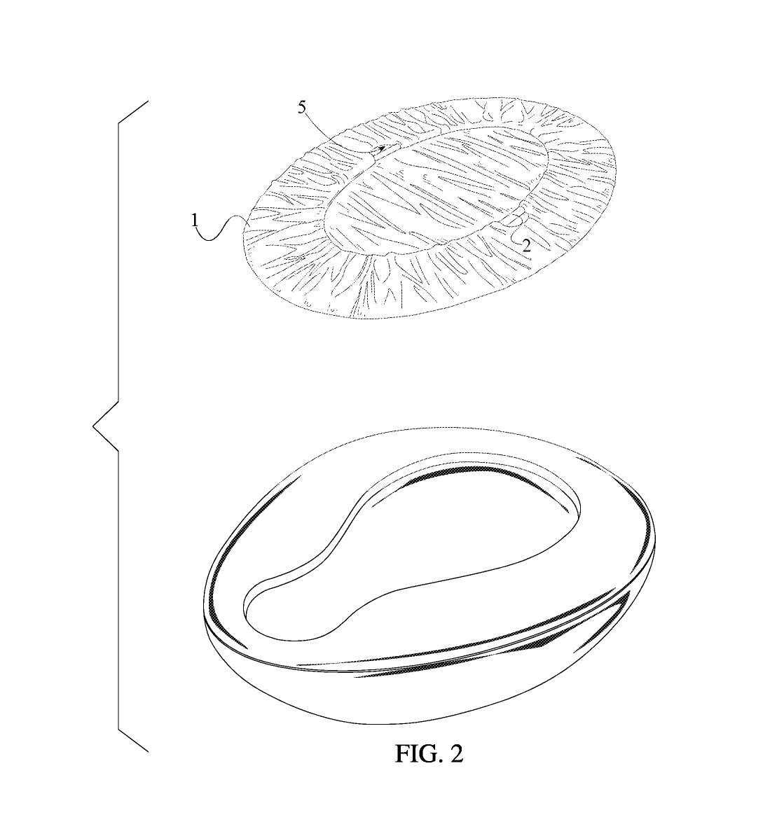

The overall configuration of the aforementioned components allows the present invention to wrap around a bedpan. Consequently, the overall configuration allows the present invention to be easily separated from a bedpan while containing waste within the lining sheet 1. The elastic loop 2 is perimetrically and slidably mounted around the lining sheet 1, as shown in FIG. 1, in order to prevent the unwanted removal of the lining sheet 1 from the bedpan. This configuration also maximizes the surface area of the lining sheet 1 around the bedpan. The first finger slot 3 traverses through the lining sheet 1. Similarly, the second finger slot 4 traverses through the lining sheet 1. This arrangement allows a user to access the elastic loop 2 and separate the lining sheet 1 from the bedpan while containing the waste within the lining sheet 1. In order to prevent the user from coming into contact with the waste within the bedpan, the first finger slot 3 and the second finger slot 4 are peripherally positioned on the lining sheet 1, and the elastic loop 2 traverses through both the first finger slot 3 and the second finger slot 4, as illustrated in both FIG. 3 and FIG. 4. The circumferential length of the elastic loop 2 is less than a perimeter of the lining sheet 1 so that the opening of the present invention is sealable and the waste is effectively contained within the lining sheet 1, as seen in the schematic view of FIG. 2. More specifically, the user is able to close the circular opening of the present invention by pulling on the elastic loop 2 through both the first finger slot 3 and the second finger slot 4.

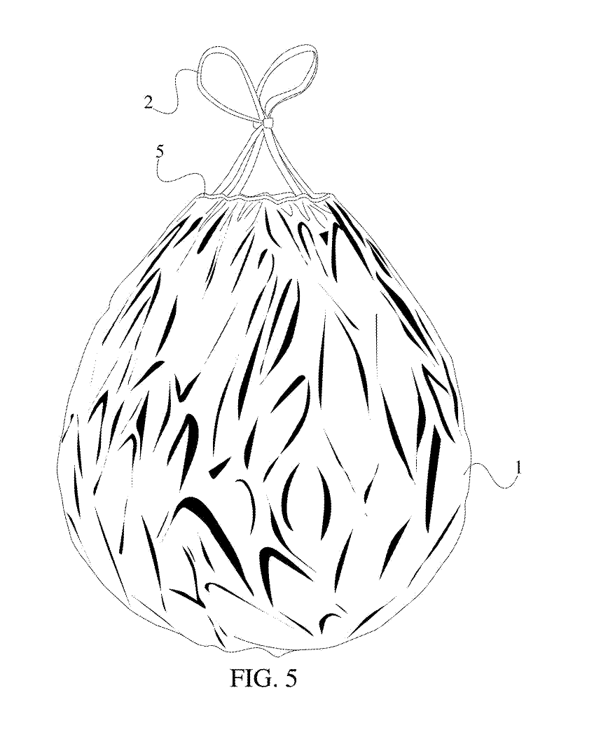

In order to secure the elastic loop 2 to the lining sheet 1, the preferred embodiment of the present invention comprises an annular sleeve 5. The annular sleeve 5 houses the elastic loop 2 and allows the elastic loop 2 to tighten the opening of the lining sheet 1, as shown in FIG. 5. As the circumferential length of the elastic loop 2 is less than the perimeter of the lining sheet 1, the annular sleeve 5 scrunches the lining sheet 1 about the elastic loop 2. The annular sleeve 5 is perimetrically connected around the lining sheet 1 so that the elastic loop 2 is far from the waste resting within the bedpan. The elastic loop 2 is slidably positioned within the annular sleeve 5. This slideable engagement allows the user to pull the elastic loop 2 and tighten the circular opening of the present invention. In the preferred embodiment of the present invention, the first finger slot 3 traverses through the annular sleeve 5. Similarly, the second finger slot 4 traverses through the annular sleeve 5. This arrangement allows the user to access the elastic loop 2 and tie the elastic loop 2 into a knot after the removal of present invention from the bedpan. More specifically, the first finger slot 3 and the second finger slot 4 are positioned opposite to each other about the elastic loop 2 in order to effectively close the opening of the lining sheet 1.

In the preferred embodiment of the present invention, the lining sheet 1 is made of plastic. The plastic prevents the waste from seeping through the lining sheet 1 and coming into contact with the bedpan. As illustrated in FIG. 3 and FIG. 4, the plastic allows the present invention to conform to the contours of the bedpan, thereby maximizing the amount of waste the present invention may retain. The lining sheet 1 is also preferably made of an opaque material. The opaque material prevents the waste from being visible from the surrounding environment of the present invention.

In alternate embodiments of the present invention, the elastic loop 2 may comprise various strengths of elasticity in order to facilitate the removal of the present invention from a bedpan. Decreased elasticity of the elastic loop 2 allows a user to quickly mount and remove the present invention from a bedpan. However, if the lining sheet 1 is easily separated or misaligned from the bedpan, the elasticity of the elastic loop 2 may be stronger so that the present invention is securely mounted onto the bedpan.

Optionally, a friction inducing layer may surround the annular sleeve 5 in order to increase the friction between the bedpan and the present invention. The friction induction layer fastens the position of the elastic loop 2 around the bedpan and prevents the lining sheet 1 from becoming misaligned while in use.

In order to use the present invention, the user stretches the elastic loop 2 until the perimeter of the lining sheet 1 exceeds that of the bedpan. The user rests the lining sheet 1 onto the bedpan until the elastic loop 2 wraps around the exterior of the bedpan and the lining sheet 1 rests at the bottom of the bedpan. More specifically, the elastic loop 2 presses against the exterior of the bedpan. If the lining sheet 1 does not readily position itself onto the contours of the bedpan, the user may press the lining sheet 1 against the contours of the bedpan so that the waste is contained within the bedpan. Upon the removal of the bedpan, the user stretches the elastic loop 2 away from the bedpan until the perimeter of the lining sheet 1 is above the bedpan. The user may simply separate the present invention from the bedpan, or the user may close the opening of the present invention in order to secure the waste within the bedpan. The user may pull the elastic loop 2 from both the first finger slot 3 and the second finger slot 4 until the perimeter of the lining sheet 1 is tightened and proceed to make a knot. Consequently, the bedpan effectively contains the waste while limiting any mess created by waste.

Although the invention has been explained in relation to its preferred embodiment, it is to be understood that many other possible modifications and variations can be made without departing from the spirit and scope of the invention as hereinafter claimed.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A disposable liner for use with bedpans, comprises:
a lining sheet;
an elastic loop;
a first finger slot;
a second finger slot;
an annular sleeve;
wherein said annular sleeve is formed including a friction inducing outer surface adapted to increase friction between said disposable liner and a bedpan used thereupon, to thereby prevent said disposable liner from becoming misaligned or unintentionally removed from said bedpan;
the elastic loop being perimetrically and slidably mounted around the lining sheet;
the first finger slot traversing through the lining sheet;
the second finger slot traversing through the lining sheet;
the first finger slot and the second finger slot being peripherally positioned on the lining sheet;
the elastic loop traversing through both the first finger slot and the second finger slot;
a circumferential length of the elastic loop being less than a perimeter of the lining sheet;
the annular sleeve being perimetrically connected around the lining sheet; and
the elastic loop being slidably positioned within the annular sleeve; and
the first finger slot and the second finger slot being positioned opposite to each other about the elastic loop.

13. The disposable liner as claimed as claim 12 comprises:
the first finger slot traversing through the annular sleeve; and
the second finger slot traversing through the annular sleeve.

14. The disposable liner as claimed as claim 12, wherein the lining sheet is made of a plastic material.

15. The disposable liner as claimed as claim 12, wherein the lining sheet is made of an opaque material.
